(19) United States
(12) Patent Application Publication
(10) Pub. No.: US 2008/0084998 A1
(43) Pub. Date: Apr. 10, 2008

(54) Encryption key management device and encryption key management method

(75) Inventor: Takuya Kontani, Inagi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/905,915

(22) Filed: Oct. 5, 2007

(30) Foreign Application Priority Data
Oct. 5, 2006 (JP) 2006-274281

(51) Int. Cl. H04L 9/14; H04L 9/30

(52) U.S. Cl. 380/45; 380/46

(57) ABSTRACT

According to one embodiment, an encryption key management device comprises a means for applying encryption processing by a common key system to a first key by using a second key generated from a random seed and an input password to record the encrypted first common key on an information recording medium, a means for applying encryption processing by a public key system to the first common key by suing a public key recorded on the information recording medium, and a means for applying stirring processing to the first common key with the encryption processing by the public key system applied thereto to record the stirred first common key on the information recording medium.

### CROSS-REFERENCE TO RELATED APPLICATIONS

This application is based upon and claims the benefit of priority from Japanese Patent Application No. 2006-274281, filed Oct. 5, 2006, the entire contents of which are incorporated herein by reference.

### BACKGROUND

1. Field

One embodiment of the invention relates to an information recording and reproducing system for recording and reproducing encrypted data to and from an information recording medium. More specifically, the present invention relates to an encryption key management device and an encryption key management method for managing an encryption key used for the encryption.

2. Description of the Related Art

As is well known, in using the forgoing information recording and reproducing system in, for example, a business organization etc., it is needed for the manager and the employee who is permitted to use the system by the manager to each independently read out the encrypted data recorded on the information recording medium and enable decrypting the encrypted data.

On the contrary, it is needed to surely prevent any person other than the manager and the employee who is permitted to use the system by the manager from reading and decrypting the encrypted data recorded on the recording medium and to sufficiently protect the data.

That is, a n encryption key management form in which only a specified plurality of users can each independently decrypt the encrypted data recorded on the recording medium by using the encryption key already used for the encryption of the data and any person other than the specified plurality of users cannot get the encryption key is strongly desired.

A configuration, storing a first and a second encryption keys in which disposable keys generated from random numbers are encrypted by use of a key intrinsic to the user and a public key are stores, and the user generates the disposable key from the first encryption key by the use of the key intrinsic to the user, and the third party generates the disposable key from the second encryption key by using a secret key, is given in Jpn. Pat. Appln. KOKAI Publication No. 11-161167.

In Japan Patent No. 3,590,143, a configuration, adding a means for encrypting a prescribed encryption key by using a public key of the third party other than a recipient and a sender of a prescribed e-mail to a main body of an e-mail encrypted by a common key encryption system; and a prescribed encryption key encrypted with the public key of the third party, is given.

Further, Jpn. Pat. Appln. KOKAI publication No. 2006-20291 discloses a configuration in which an access ticket obtained by encrypting a secret key generated from a password and a random number is responded to a client together with the random number, the client transmits the secret key and the access ticket generated from the random number and the password to a server, and the server decrypts the access ticket with an decryption key to extract the secret key.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred block diagram for explaining an outline of an information recording and reproducing system in an embodiment of the invention;

FIG. 2 is a preferred block diagram for explaining an example of an encryption and decryption processing control unit of the system in the embodiment;

FIG. 3 is a preferred flowchart for explaining an example of processing operations performed by a manager side of the system in the embodiment;

FIG. 4 is a preferred view for explaining an example of processing operations performed by the manager side of the system in the embodiment;

FIG. 5 is a preferred flowchart for explaining an example of processing operations performed by an employee side of the system in the embodiment;

FIG. 6 is a preferred view for schematically explaining an example of processing operations performed by the employee side of the system in the embodiment;

FIG. 7 is a preferred flowchart for explaining another example of the processing operations performed by the employee side of the system in the embodiment;

FIG. 8 is a preferred view for schematically explaining another example of the processing operations performed by the manager side and employee side of the system in the embodiment; and

FIG. 9 is a preferred flowchart for explaining another example of the processing operations performed by the manager side of the system in the embodiment.

### DETAILED DESCRIPTION

Various embodiments according to the invention will be described hereinafter with reference to the accompanying drawings. In general, according to one embodiment of the invention, an encryption key management device comprises a means for applying encryption processing by a common key system to a first key by using a second key generated from a random seed and an input password to record the encrypted first common key on an information recording medium, a means for applying encryption processing by a public key system to the first common key by suing a public key recorded on the information recording medium, and a means for applying stirring processing to the first common key with the encryption processing by the public key system applied thereto to record the stirred first common key on the information recording medium.

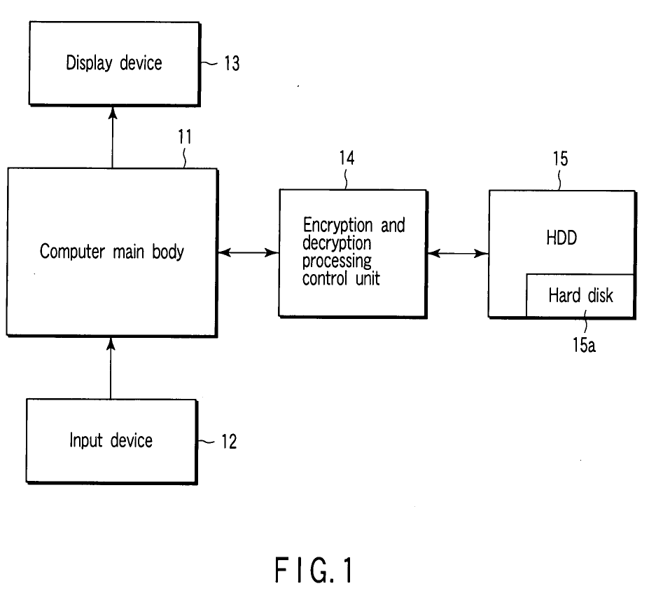

FIG. 1 illustrates an outline of an information recording and reproducing system to be given in the embodiment. The system has a configuration in which an input device 12 such as a keyboard and a mouse, and a display device 13 made of liquid crystal etc., are connected to a computer main body 11.

A hard disk drive (HDD) 15 that is information recording and reproducing device with a large capacity is externally connected to the computer main body 11 via an encryption and decryption processing control unit 14. In this case, the control unit 14 may be configured to be built-in the computer main body 11.

The computer main body 11 can encrypt its internal data by means of the control unit 14 to record the encrypted data on a hard disk 15a by means of the HDD 15, and also can read out the encrypted data recorded in the hard disk 15a by the use of the HDD 15, and decrypt the read out data by means of the control unit 14 to take in it inside the computer main body 11.

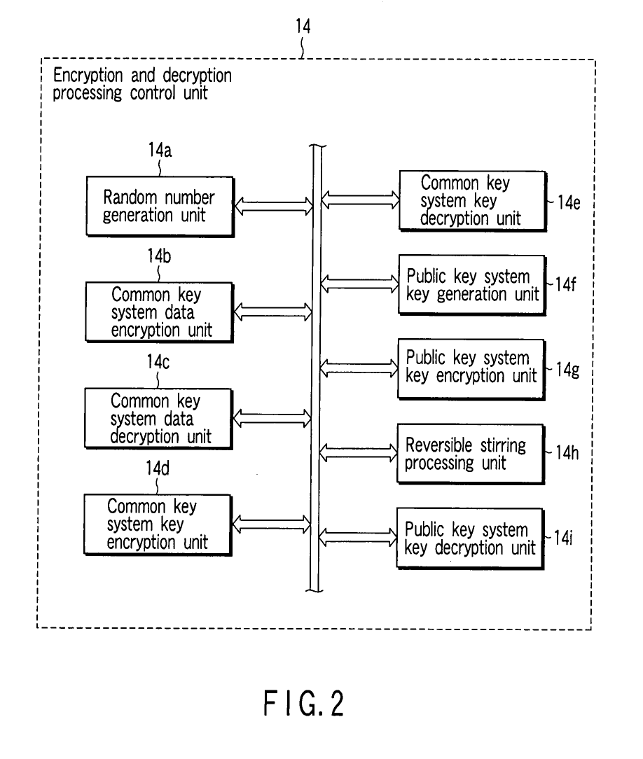

FIG. 2 illustrates an example of the control unit 14. The control unit 14 includes a random number generation unit 14a, a common key system data encryption unit 14b, a common key system data decryption unit 14c, a common key system key encryption unit 14d, a common key system key decryption unit 14e, a public key system key generation unit 14f, a public key system key encryption unit 14g, a reversible stirring processing unit 14h, and a public key system key decryption unit 14i.

Among of them, the random number generation unit 14a generates a random seed (RS) and a common key Kb. The data encryption unit 14b applies encryption processing to input data by using the common key Kb generated by the generation unit 14. Further, the data decryption unit 14c applies decryption processing to the data encrypted by the data encryption unit 14b by the use of the common key Kb.

The key encryption unit 14d applies encryption processing to the common key Kb generated from the generation unit 14a by using a common key Ku in which a password set by a user and an RS generated from the generation unit 14a are combined with each other. Moreover, the key decryption unit 14e applies decryption processing to the encryption processing result, COM [Ku] {kb}, by the use of the common key Ku.

The key generation unit 14f generates a public key Kp. The key encryption unit 14g applies encryption processing to a common key Kb by using the public key Kp generated by the key generation unit 14f. Furthermore, the stirring processing unit 14h applies reversible encryption such as reversible hash to an encryption processing result from the key encryption unit 14g. The key decryption unit 14i applies decryption processing to the encryption processing result from the key encryption unit 14g by using a secret key Ks corresponding to the public key Kp.

In the information recording and reproducing system to be configured as described above, the following will explain the management of the encryption key using the encryption and decryption processing control unit 14. The following explanation will explain the case, as an example, in which a manager inside a company organization and employees who are permitted to use the system by the manager are set as users.

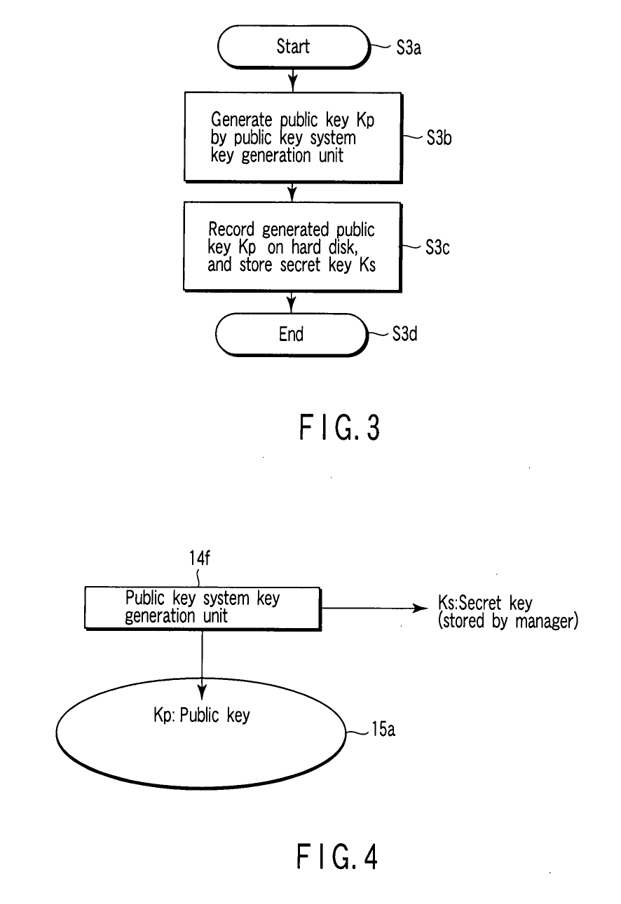

FIG. 3 illustrates a flowchart getting together processing operations performed by the manager side when a new HDD 15 is connected to the processing control unit 14, and FIG. 4 schematically illustrates the processing operations. When the processing operations are started (step S3a), the key generation unit 14f generates the public key Kp in a step S3b.

After this, in a step 3c, the public key Kp is written into the hard disk 15a, the secret key Ks corresponding to the public key Kp is stored separately, and the processing is ended (step 3d). In a state in which the public key Kp is recorded on the hard disk 15a in the manner given above, the system is transferred to an employee.

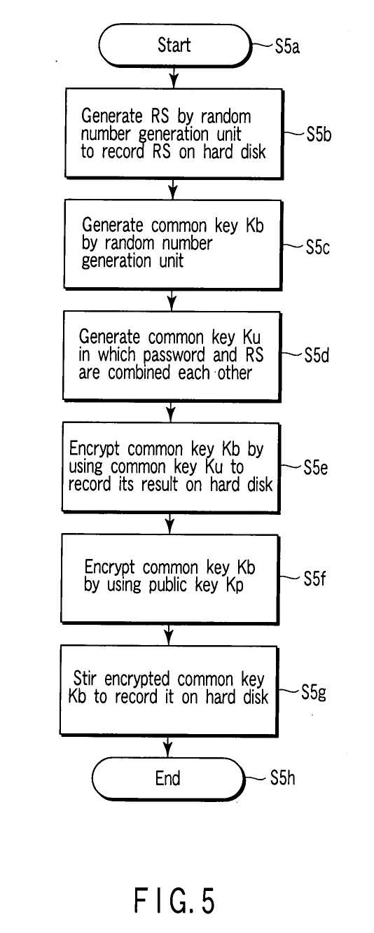

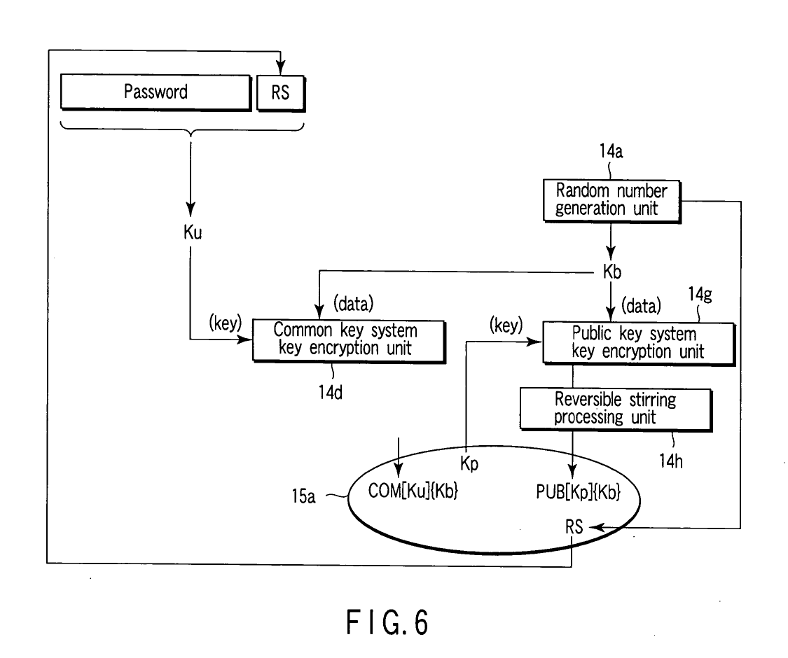

FIG. 5 illustrates a flowchart in which the processing operations conducted on a side of an employee to whom the recording and reproducing system transferred, and FIG. 6 schematically illustrates the processing operations. In other words, when the processing operations start (step S5a), the random number generation unit 14a generates the RS in a step S5b, writes the RS into the hard disk 15a, and also the generation unit 14a generates the common key Kb in a step S5c.

After this, the data encryption unit 14b applies the encryption processing by the common key system to the input data, and the encrypted data is output to the HDD 15. Thus, the data is encrypted and recorded on the hard disk 15a.

In a step S5d, then, the password input through the input device 12 and the RS generated from the generation unit 14a are combined with each other and the common key Ku is generated. In a step S5e, the key encryption unit 14d uses the common key Ku to apply the encryption processing by the common key system to the common key Kb generated from the random number generation unit 14a by using the common key Ku, and writes the encryption processing result, COM [Ku]{kb}, into the hard disk 15a.

Meanwhile, in a step S5f, the key encryption unit 14g uses the public key Kp written on the hard disk 15a to apply the encryption processing by the public key system to the common key Kb generated from the generation unit 14a. In a step S5g, the stirring processing unit 14h applies the stirring processing to the common key Kb encrypted by the public key system, records the stirring processing result PUB [Kp]{kb} on the hard disk 15a, and terminates the processing (step S5h).

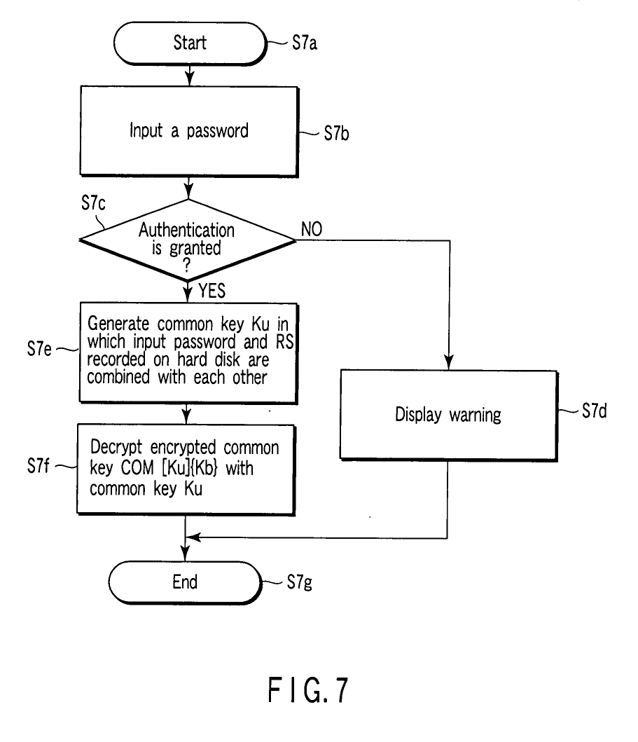

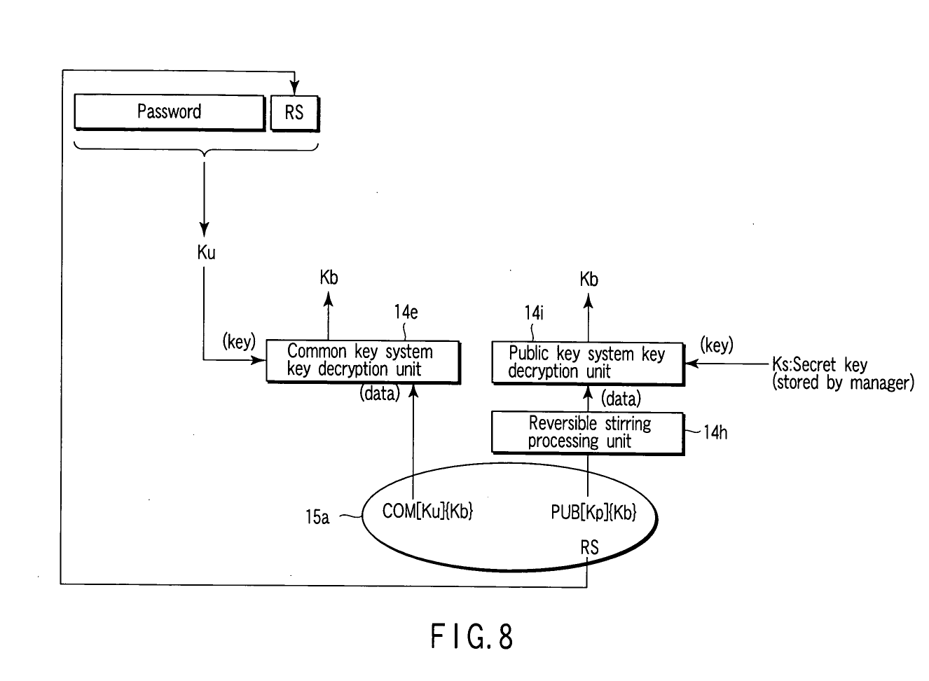

FIG. 7 illustrates a flowchart in which, as mentioned above, the processing operations so that the employee reads out the encrypted data from the hard disk 15a with the common key COM [Ku] {kb} encrypted by the common key system using the common key Ku and the common key PUB [Kp] {Kb} encrypted and applied the reversible stirring processing in the public key system using the public key Kp recorded thereon to apply the decryption processing, and FIG. 8 illustrates the processing operation schematically.

In other words, after the start of the processing operations (step S7a), when a password is input through the input device 12 in a step S7b, it is determined whether or not the authentication by the password is granted in a step S7c, if the authentication is not granted (NO, in step S7c), a warning indicating the fact that the authentication is not granted is displayed on the display device 13 in a step 7d, and the processing is ended (step S7g).

If the authentication is granted through the password (YES, in step S7c), the common key Ku made by combining the password input through the input device 12 and the RS recorded on the hard disk 15a is generated.

In a step S7f, the key decryption unit 14e applies the decryption processing to the encrypted common key COM [Ku] {Kb} recorded on the hard disk 15a through the common key system by using the common key Ku generated in the step S7e to obtain the common key Kb, and then, terminates the processing (step S7g).

After this, the data decryption unit 14c uses the decrypted common key Kb to apply the decryption processing through the common key system to the data read out from the hard disk 15a, outputs the decrypted data to the computer main body 11, and thereby, decrypts the encrypted data recorded on the hard disk 15a to supply the decrypted data to the main body 11.

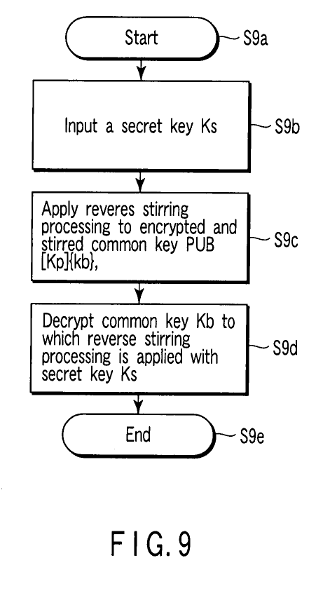

FIG. 9 illustrates a flowchart in which, as mentioned above, the processing operations, such that the manager reads out the encrypted data from the hard disk 15a with the common key COM [Ku] [Kb] encrypted in the common key system using the common key Ku and the common key PUB [Kp] {Kb} encrypted and applied the reversible stirring processing in the public key system using the public key Kp are recorded thereon, are put together.

In other words, the processing operations start (step S9a) and the input device 12 inputs the secret key Ks in a step S9b, then, the stirring processing unit 14h applies stirring processing to the encrypted and stirred common key PUB [Kp]{Kb} recorded in the hard disk 15a by a reverse manner of the time when it is stirred in a step S9c.

Then, in a step S9d, the key decryption unit 14i applies the decryption processing by the public key system using the secret key Ks input in the step S9b to the common key Kb after the applying of the reversed stirring processing to obtain the common key Kb, and ends the processing (step S9e).

After this, the data decryption unit 14c uses the decrypted common key Kb to apply the decryption processing by the common key system to the data read out from the hard disk 15a, outputs the decrypted data to the computer main body 11, and then, decrypts the encrypted data recorded on the hard disk 15a to supply the decrypted data to the main body 11.

According to the foregoing embodiment, the employee may easily obtain the common key Kb by inputting its password and the manager may easily obtain the common key Kb by using the secret key Ks. That is to say, only the specified plurality of users can easily obtain the key to decode the decryption independently from one another, decrypt the data recorded on the information recording medium (hard disk 15a), and make the treatment for the user convenient.

The common key Kb to encrypt the data encrypts the data by the common key system by using the public key Ku in which the password to be set by the employee and the RS generated from the random number generation unit 14a to record the encrypted data on the hard disk 15a, and also encrypts the data by the public key system by using the public key Kp of which the secret key Ks is owned by the manager, and applies the reversible stirring processing to the encrypted data to record it on the hard disk 15a. Therefore, if the third party reads out the data recorded on the hard disk 15a, it is hard for the third party to get the common key Kb, and the data recorded on the hard disk 15a can be practically sufficiently protected.

Especially, since the employee encrypts the common key Kb generated from the random number generation unit 14a by using the public key Kp which has been recorded on the hard disk 15a by the manager, if the employee itself updates the common key Kb without asking manager's permission, the manager can obtain the common key Kb by using the secret key Ks, so that the information recording and reproducing system may further enhance the degree of freedom for the user, and actualize the protection of the data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An encryption key management device for use in an information recording and reproducing system which applies encryption processing by a common key system to data by using a first common key to record the encrypted data on an information recording medium, and also applies decryption processing by the common key system to the encrypted data read out from the information recording medium by using the first common key, comprising:
a public key generation unit configured to generate a public key to record it on the information recording medium;
a common key generation unit configured to generate the first common key and an random seed to record the random seed on the information recording medium;
a common key system key encryption unit configured to generate a second key on the basis of the RS generated from the common key generation unit and of an input password, to apply encryption processing by the common key system to the first common key generated from the common key generation unit by using the generated second common key, and to record the encrypted first common key on the information recording medium;
a public key system key encryption unit configured to apply encryption processing by a public key system to the first common key generated from the common key generation unit by using a public key generated from the public key generation unit to be recorded on the information recording medium; and
a reversible stirring unit configured to apply stirring processing to the first common key applied encryption processing by the public key system key encryption unit to record the encrypted first common key on the information recording medium.

2. The encryption key management device according to claim 1, further comprising:
a common key system key decryption unit configured to generate the second common key on the basis of the random seed generated from the common key generation unit to be recorded on the information recording medium and of the input password and to apply decryption processing by the common key system to the first common key encrypted by the common key system key encryption unit to be recorded on the information recording medium by using the generated second common key; and
a public key system key decryption unit configured to apply decryption processing by the public key system to the first common key applied stirring processing reverse to the stirring processing by the reversible stirring unit to be recorded on the information recording medium by using a secret key corresponding to the public key generated from the public key generation unit.

3. The encryption key management device according to claim 1, wherein
the common key generation unit is configured to generate the first common key and RS from a random number generator.

4. The encryption key management device according to claim 1, wherein
the information recording medium is a hard disk.

5. An encryption key management method for use in an information recording and reproducing system which applies encryption processing by a common key system to data by using a first common key to record the encrypted data on an information recording medium, and also applies decryption processing by the common key system to the encrypted data read out from the information recording medium by using the first common key, comprising:
generating a public key to record it on the information recording medium:
generating the first common key and RS to record them on the information recording medium:
generating a second common key on the basis of the RS and an input password, and applying encryption processing by the common key system to the first common key by using the generated second common key to record the encrypted first common key on the information recording medium;
using the public key recorded on the information recording medium to apply encryption processing by a public key system to the first common key by using the public key recorded on the information recording medium; and
applying stirring processing to the first common key with the encryption processing applied thereto to record the stirred first key on the information recording medium.

6. The encryption key management method according to claim 5, further comprising:
generating the second common key on the basis of the RS recorded on the information recording medium and the input password, and applying decryption processing by the common key system to the first common key encrypted to be recorded on the information recording medium by the use of the generated second common key; and
applying decryption processing by public key system to the first common key applied stirring processing reverse to the stirring processing and recorded on the information recording medium by using a secret key corresponding to the public key.

7. The encryption key management method according to claim 5, wherein
the first common key and the random seed are generated from a random number generator.

8. The encryption key management method according to claim 5, wherein
the information recording medium is a hard disk.
